(19) United States
(12) Patent Application Publication
(10) Pub. No.: US 2006/0277650 A1
(43) Pub. Date: Dec. 14, 2006

(54) Protective garment having cuff-forming member

(76) Inventors: Patricia K. Waters, Tipp City, OH (US); William L. Grilliot, Dayton, OH (US); Mary I. Grilliot, Dayton, OH (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/135,909

(22) Filed: May 24, 2005

(51) Int. Cl. A62B 17/00

(52) U.S. Cl. 2/81

(57) ABSTRACT

For a firefighter or for an emergency rescue worker, a protective garment comprises an arm-covering or leg-covering sleeve, which comprises an outer shell, a lining system within the outer shell, a wristlet or an anklet, which is attached non-detachably to the lining system, and a cuff-forming member, which is attached non-detachably to the lining system, which extends beyond the lining system, and which is attached detachably, as via a hook-and-loop fastening device, to an outer or inner surface of the outer shell. The cuff-forming member can be thus attached at any location within a range of possible locations along the garment sleeve. The cuff-forming member, if visible at the cuff end of the outer shell, provides a visible indication that the lining system is present.

### STATEMENT REGARDING FEDERALLY SPONSORED RESEARCH OR DEVELOPMENT

This invention was made with Government support under Contract No. W91CRB-04-C-027 awarded by the United States Department of the Army. The Government has certain rights in the invention.

### TECHNICAL FIELD OF THE INVENTION

This invention pertains to a protective garment, such as a protective coat, protective coveralls, or protective trousers, for a firefighter or for an emergency rescue worker. This invention provides, at an arm-covering or leg-covering sleeve, a cuff-forming member attached to a lining system of the protective garment and to an outer or inner surface of an outer shell of the protective garment.

### BACKGROUND OF THE INVENTION

U.S. Pat. No. RE35,682 discloses a protective coat having what is described as a reservoir cuff. A moisture barrier extends to and is attached, via a hook-and-loop fastener, to an outer end of a sleeve of the protective coat. A so-called reservoir member, which is attached to the moisture barrier, extends to and is sewn to an outer end of a thermal barrier. A cuff element, which may be also called a wristlet, is sewn to the outer end of the thermal barrier.

U.S. Pat. No. 4,768,283 exemplifies protective garments of related interest. An inner liner of a protective coat has cuff portions, which are attached to and within arm-covering sleeves of the protective coat. An inner liner of a pair of protective trousers has cuff portions, which are attached to and within leg-covering portions of the pair of protective trousers.

Herein, as a matter of terminology, it is convenient to refer to sleeves of a protective coat as arm-covering sleeves and to refer to leg portions of a pair of protective trousers as leg-covering sleeves. It follows that a suit of protective coveralls has both arm-covering and leg-covering sleeves. An arm-covering sleeve may comprise an outer shell, a lining system, and a wristlet. A leg-covering sleeve may comprise an outer shell, a lining system, and an anklet. In either, the lining system may comprise an intermediate liner providing a moisture barrier and an inner liner providing a thermal barrier, but the inner liner may be sometimes omitted.

### SUMMARY OF THE INVENTION

This invention provides a protective garment for a firefighter or for an emergency rescue worker. The protective garment comprises an arm-covering or leg-covering sleeve, which comprises an outer shell having an outer surface and an inner surface, a lining system within the outer shell, and a cuff-forming member, which is attached to the lining system and to one said surface of the outer shell.

If the protective garment comprises an arm-covering sleeve, the arm-covering sleeve may comprise a wristlet, which is attached non-detachably to the lining system. If the protective garment comprises a leg-covering sleeve, the leg-covering sleeve may comprise an anklet, which is attached non-detachably to the lining.

Preferably, the cuff-forming member is attached non-detachably to the lining system. Preferably, the cuff-forming member is attached detachably to the outer surface of the outer shell. Preferably, the cuff-forming member is attached detachably to the outer surface of the outer shell, via hook-and-loop fastening means enabling the cuff-forming member to be thus attached at any location within a range of possible locations.

### BRIEF DESCRIPTION OF THE DRAWINGS

FIG. 1 is a fragmentary view of a portion of an arm-covering sleeve of a protective coat embodying this invention. The illustrated portion includes a cuff end. FIG. 2 is a sectional view taken along line 2-2 of FIG. 1, in a direction indicated by arrows.

FIG. 3 is a fragmentary view of a portion of a leg-covering sleeve of a protective coat embodying this invention. The illustrated portion includes a cuff end. FIG. 4 is a sectional view taken along line 4-4 of FIG. 1, in a direction indicated by arrows.

FIGS. 5 and 6 are sectional views, which are similar to FIG. 4, except that a cuff-forming member is illustrated as being attached to an outer surface of an outer shell, via hook-and-loop fastening means, at three different locations in FIGS. 4, 5, and 6.

FIG. 7 is a sectional view, which is analogous to FIGS. 4, 5, and 6 but which illustrates a cuff-forming member being attached to an inner surface of an outer shell, via hook-and-loop fastening means.

### DETAILED DESCRIPTION OF THE ILLUSTRATED EMBODIMENTS

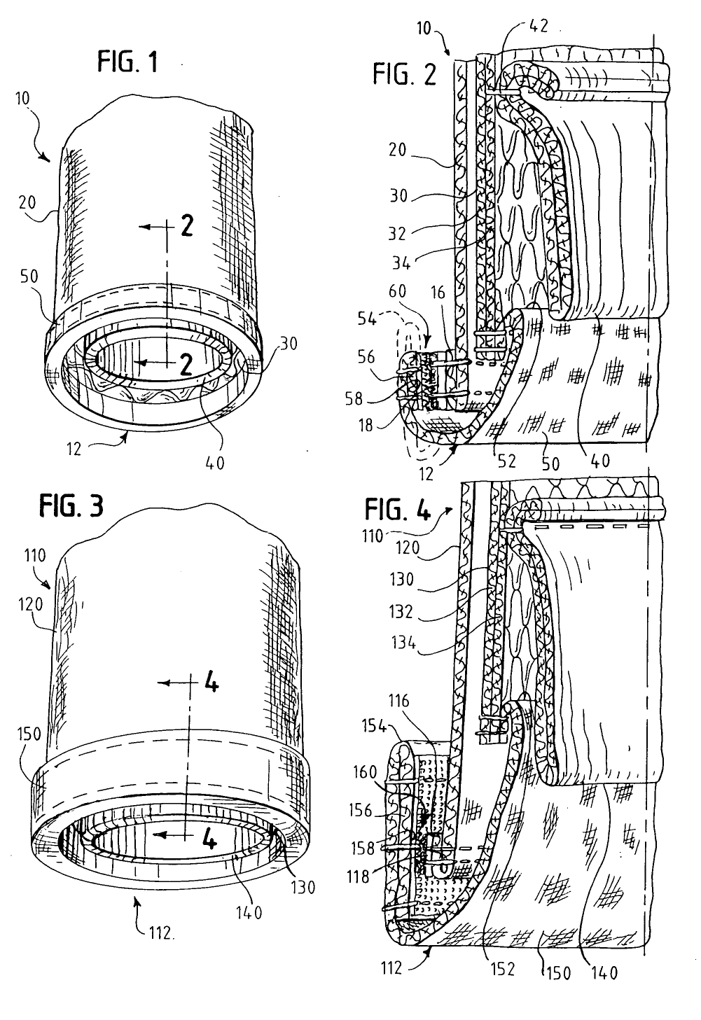

As illustrated in FIGS. 1 and 2, an arm-covering sleeve 10 of a protective coat comprises an outer shell 20, a lining system 30 within the outer shell 20, a wristlet 40, which is attached non-detachably to the lining system 30 and which extends toward a cuff end 12 of the arm-covering sleeve 10, and a cuff-forming member 50. The wristlet 40 is sewn to the lining system 30, via stitches 42, so as to be non-detachably attached to the lining system 30. Moreover, the protective coat conforms in materials, in construction, and otherwise to standards promulgated by the National Fire Protection Association (NFPA).

As illustrated, the lining system 30 comprises an intermediate liner 32, which provides a moisture barrier, and an inner liner 34, which provides a thermal barrier. If the inner liner 34 is provided, the protective coat conforms to NFPA 1971 “Protective Ensemble for Structural Fire Fighting.” If the inner liner 34 is omitted, the protective coat conforms to NFPA 1977 “Protective Clothing and Equipment for Wildland Fire Fighting.”

The cuff-forming member 50 is made from the material from which the outer shell 20 is made, e.g., Nomex™ aramid fabric or Kevlar™ aramid fabric. The outer shell 20 is folded outwardly so as to form a hem 16. At an inner end 52 of the cuff-forming member 50, the cuff-forming member 50 is sewn to the lining system 30, so as to be non-detachably attached to the lining system 30. The cuff-forming member 50 extends beyond the lining system 30, beyond the outer shell 20, and is turned outwardly. At an outer end 54 of the cuff-forming member 50, the cuff-forming member 50 is folded inwardly so as to form a hem 56, which is attached to the hem 16 of the arm-covering sleeve 10, at an inner surface 58 of the hem 56 and at an outer surface 18 of the hem 16 and via hook-and-loop fastening means 60, so as to be detachably attached to the outer surface 18, which at the cuff end 12 is an outer surface 18 of the arm-covering sleeve 10. As indicated by broken lines in FIG. 2, the hook-and-loop fastening means 60 enables the cuff-forming member 50 to be thus attached at any location within a range of possible locations along the arm-covering sleeve 10.

Advantageously, because the cuff-forming member 50 is attached non-detachably to the lining system 30, the cuff-forming member 50, if visible at the cuff end 12 of the arm-covering sleeve 10, provides a visual indication that the lining system 30 is present.

As illustrated in FIGS. 3 and 4, a leg-covering sleeve 110 of a pair of protective trousers comprises an outer shell 120, a lining system 130 within the outer shell 120, an anklet 140, which is attached non-detachably to the lining system 130 and which extends toward a cuff end 112 of the leg-covering sleeve 110, and a cuff-forming member 150. The lining system 130 comprises an intermediate liner 132, which provides a moisture barrier, and an inner liner 134, which provides a thermal barrier. The anklet 140 is sewn to the lining system 130, via stitches 142, so as to be non-detachably attached to the lining system 130.

As illustrated, the lining system 130 comprises an intermediate liner 132, which provides a moisture barrier, and an inner liner 134, which provides a thermal barrier. If the inner liner 134 is provided, the protective coat conforms to NFPA 1971 “Protective Ensemble for Structural Fire Fighting.” If the inner liner 134 is omitted, the protective coat conforms to NFPA 1977 “Protective Clothing and Equipment for Wildland Fire Fighting.”

The cuff-forming member 150 is made from the material from which the outer shell 120 is made, e.g., Nomex™ aramid fabric or Kevlar™ aramid fabric. The outer shell 120 is folded outwardly so as to form a hem 116. At an inner end 152 of the cuff-forming member 150, the cuff-forming member 150 is sewn to the lining system 130, so as to be non-detachably attached to the lining system 130. The cuff-forming member 150 extends beyond the lining system 130, beyond the outer shell 120, and is turned outwardly. At an outer end 154 of the cuff-forming member 150, the cuff-forming member 150 is folded inwardly so as to form a hem 156, which is attached to the hem 116 of the leg-covering sleeve 110, at an inner surface 158 of the hem 156 and at an outer surface 118 of the hem 156 and via hook-and-loop fastening means 160, so as to be detachably attached to the outer surface 118, which at the cuff end 112 is an outer surface 118 of the leg-covering sleeve 110. As indicated by broken lines in FIG. 4, the hook-and-loop fastening means 160 enables the cuff-forming member 150 to be thus attached at any location within a range of possible locations along the leg-covering sleeve 110.

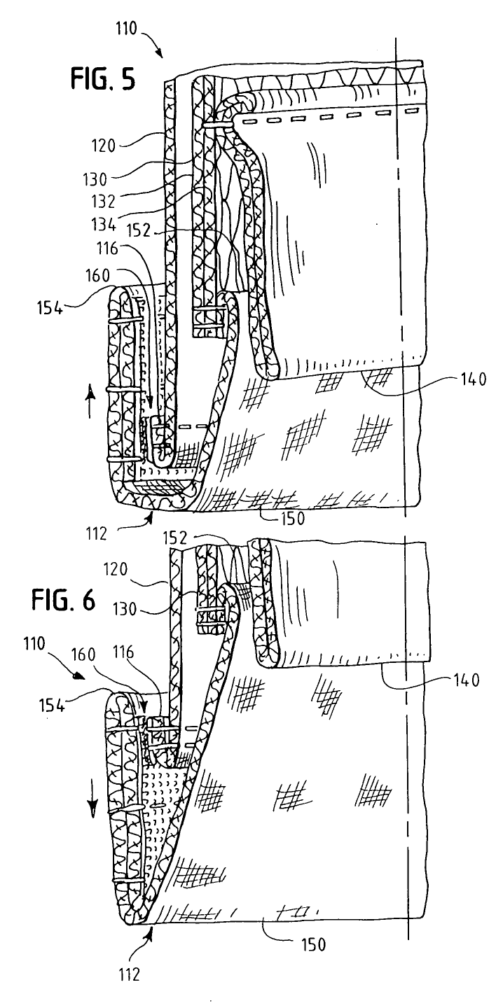

In FIGS. 4, 5, and 6, respectively, the cuff-forming member 150 is illustrated as being attached to the outer surface 118 at three different locations within the range of possible locations along the leg-covering sleeve 110.

Advantageously, because the cuff-forming member 150 is attached non-detachably to the lining system 130, the cuff-forming member 150, if visible at the cuff end 112 of the leg-covering sleeve 110, provides a visual indication that the lining system 130 is present.

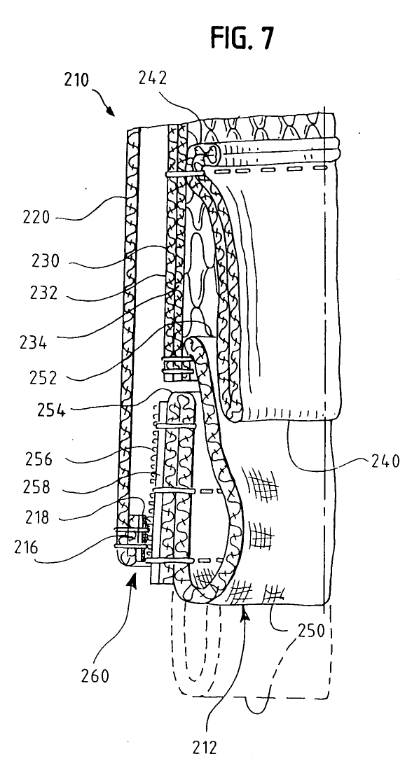

As illustrated in FIG. 7, which is analogous to FIGS. 4, 5, and 6, a leg-covering sleeve 210 of a pair of protective trousers comprises an outer shell 220, a lining system 230 within the outer shell 220, an anklet 240, which is attached non-detachably to the lining system 230 and which extends toward a cuff end 212 of the leg-covering sleeve 210, and a cuff-forming member 250.

The lining system 230 is similar to the lining system 130 illustrated in FIGS. 4, 5, and 6 and described above and, except as illustrated and described herein, the other elements named and described in the preceding paragraph are similar to the similarly named elements illustrated in FIGS. 4, 5, and 6 and described above.

The outer shell 250 is folded inwardly to form a hem 216. At an inner end 252 of the cuff-forming member 250, the cuff-forming member 250 is sewn to the lining system 230, so as to be non-detachably attached to the lining system 230. The cuff-forming member 250 extends beyond the lining system 230, beyond the outer shell 220, and is turned outwardly. At an outer end 254 of the cuff-forming member 250, the cuff-forming member 250 is folded inwardly so as to form a hem 256, which is attached to the hem 216 of the outer shell 220, at an outer surface 258 of the hem 256 and at an inner surface 218 of the hem 216 and via hook-and-loop fastening means 260, so as to be detachably attached to the inner surface 218, which at the cuff end 212 is an inner surface 218 of the leg-covering sleeve 210. The hook-and-loop fastening means 260 enables the cuff-forming member 250 to be thus attached at any location within a range of possible locations along the leg-covering sleeve 210.

Advantageously, because the cuff-forming member 250 is attached non-detachably to the lining system 230, the cuff-forming member 250, if visible at the cuff end 212 of the leg-covering sleeve 210, provides a visual indication that the lining system 230 is present.

1. A protective garment for a firefighter or for an emergency rescue worker, wherein the protective garment comprises an arm-covering or leg-covering sleeve, which comprises an outer shell having an outer surface and an inner surface, a lining system within the outer shell, and a cuff-forming member, which is attached to the lining system and to one said surface of the outer shell.

2. A protective garment for a firefighter or for an emergency rescue worker, wherein the protective garment comprises an arm-covering sleeve, which comprises an outer shell having an outer surface and an inner surface, a lining system within the outer shell, a wristlet, which is attached non-detachably to the lining system, and a cuff-forming member, which is attached to the lining system and to one said surface of the outer shell.

3. A protective garment for a firefighter or for an emergency rescue worker, wherein the protective garment comprises a leg-covering sleeve, which comprises an outer shell having an outer surface and an inner surface, a lining system within the outer shell, an anklet, which is attached non-detachably to the lining system, and a cuff-forming member, which is attached to the lining system and to one said surface of the outer shell.

4. The protective garment of claim 1, 2, or 3, wherein the cuff-forming member is attached detachably to the outer surface of the outer shell.

5. The protective garment of claim 1, 2, or 3, wherein the cuff-forming member is attached non-detachably to the lining system and detachably to the outer surface of the outer shell.

6. The protective garment of claim 4, wherein the cuff-forming member is attached detachably to the outer surface of the outer shell at any location within a range of possible locations along said sleeve.

7. The protective garment of claim 4, wherein the cuff-forming member is attached detachably to the outer surface of the outer shell, via hook-and-loop fastening means enabling the cuff-forming member to be thus attached at any location within a range of possible locations along said sleeve.

8. The protective garment of claim 5, wherein the cuff-forming member is attached detachably to the outer surface of the outer shell at any location within a range of possible locations along said sleeve.

9. The protective garment of claim 5, wherein the cuff-forming member is attached detachably to the outer surface of the outer shell, via hook-and-loop fastening means enabling the cuff-forming member to be thus attached at any location within a range of possible locations along said sleeve.

10. The protective garment of claim 1, 2, or 3, wherein the cuff-forming member is attached detachably to the inner surface of the outer shell.

11. The protective garment of claim 1, 2, or 3, wherein the cuff-forming member is attached non-detachably to the lining system and detachably to the inner surface of the outer shell.

12. The protective garment of claim 10, wherein the cuff-forming member is attached detachably to the inner surface of the outer shell at any location within a range of possible locations along said sleeve.

13. The protective garment of claim 10, wherein the cuff-forming member is attached detachably to the inner surface of the outer shell, via hook-and-loop fastening means enabling the cuff-forming member to be thus attached at any location within a range of possible locations along said sleeve.

14. The protective garment of claim 11, wherein the cuff-forming member is attached detachably to the inner surface of the outer shell at any location within a range of possible locations along said sleeve.

15. The protective garment of claim 11, wherein the cuff-forming member is attached detachably to the inner surface of the outer shell, via hook-and-loop fastening means enabling the cuff-forming member to be thus attached at any location within a range of possible locations along said sleeve.
